(19) United States
(12) Patent Application Publication
(10) Pub. No.: US 2019/0131839 A1
(43) Pub. Date: May 2, 2019

(54) SPOKE TYPE ROTOR

(71) Applicant: NEW MOTECH CO., LTD., Gwangju (KR)

(72) Inventors: Jeong Cheol JANG, Gwangju (KR); Gyeong Sik YANG, Gwangju (KR); Seung Hoon LEE, Gwangju (KR); Nam Jong KIM, Gwangju (KR)

(73) Assignee: NEW MOTECH CO., LTD., Gwangju (KR)

(21) Appl. No.: 16/093,971

(22) PCT Filed: Mar. 20, 2017
(86) PCT No.: PCT/KR2017/002925

§ 371 Date: Oct. 16, 2018

(30) Foreign Application Priority Data
Jun. 7, 2016 (KR) 10-2016-0070059

(51) Int. Cl. H02K 1/27; H02K 1/30

(52) U.S. Cl. CPC H02K 1/2773; H02K 1/30

(57) ABSTRACT

A spoke type rotor includes: a plurality of rotor cores, radially arranged, having neither base nor bridge; a permanent magnet arranged in each gap between the plurality of rotor cores; a space formed between the inner circumferential surfaces of the plurality of rotor cores and of the permanent magnets and a through hole into which a rotation shaft is inserted; and a molding member for reducing magnetic flux leakage filling the space.

### TECHNICAL FIELD

The present invention relates to a spoke type rotor. More specifically, the present invention relates to a spoke type rotor which is capable of reducing manufacturing costs and improving motor performance by reducing the weight of the rotor and the core loss in a spoke type permanent magnet motor.

### BACKGROUND ART

Motors, which are machines that obtain rotary force from electrical energy, include a stator and a rotor. The rotor interacts with the stator electromagnetically, and rotates by a force produced from the interaction between a magnetic field and currents flowing in coils.

Permanent magnet motors using a permanent magnet for generating a magnetic field include a surface mounted permanent magnet motor and an interior type permanent magnet motor.

In particular, a spoke type permanent magnet motor, as a type of the interior type permanent magnet motor, structurally has a high magnetic flux concentration, and thus can generate high torque and high power and make a motor in a smaller size compared with motors having the same power. The spoke type permanent magnet motor can be applied as a driving motor for washing machines, electric vehicles, etc., which require high torque and high power properties.

The typical rotor of a spoke type permanent magnet motor is disclosed in Korean Patent Laid-Open No. 10-2013-0085336. As illustrated in FIG. 7, the rotor of the spoke type permanent motor includes permanent magnets (B) arranged in the radial direction with respect to a rotation shaft (A) and rotor cores (C) provided to support the permanent magnets (B) and form the path of magnetic flux. Each of the rotor core (C) includes a cylindrical base (D) and a bridge (E) which connect the rotor cores with each other.

According to the conventional spoke type permanent magnet motors, part of the magnetic flux may leak into the rotation shaft (A) through the bridges (E) and base (D) of the rotor cores (C). The increase in magnetic flux leakage results in the decrease in output, and the use of permanent magnets by the conventional spoke type permanent magnet motors is greater than that by the motors with the same power. Thus, there is a disadvantage in terms of material costs or compactness of motors.

In particular, in the case where the rotor cores (C) are connected with each other by the bridges (E) and base (D), a precise design is required to retain the structural strength for the width of the bridges (E). In the case where the bridges (E) are designed to have a narrow width, there is a problem that the bridges (E) are damaged at the high-speed rotation of the motor. On the other hand, in the case where the bridges (E) are designed to have a broad width, there is a problem that the magnetic flux leakage increases, etc., which leads to motor performance degradation due to core loss.

In addition, the conventional rotor cores (C) are coupled to each other by inserting a metal coupling member into a coupling hole (C′) formed in each rotor core (C), and the coupling is finished with rivets. Thus, there is a concern that magnetic flux leaks into the coupling member through the coupling hole (C′), which not only adversely affects motor performance but also causes the scattering of the rotor cores and permanent magnets due to flowability of the coupling member at the high-speed rotation of the motor.

### DISCLOSURE OF INVENTION

### Technical Problem

The present invention is directed to reduce the weight of a rotor core.

Also, the present invention is directed to improve motor performance by reduction of core loss by subjecting rotor cores and permanent magnets to insert molding and coupling the plurality of rotor cores and the permanent magnets that constitute a rotor with a molding member, thereby retaining firm coupling and simultaneously reducing magnetic flux leakage into a rotation shaft.

### Solution to Problem

A spoke type rotor according to the present invention includes:

a plurality of rotor cores (10), radially arranged, having neither base nor bridge;

a permanent magnet (20) arranged in each gap between the plurality of rotor cores (10);

a space (S) formed between the inner circumferential surfaces of the plurality of rotor cores (10) and of the permanent magnets (20) and a through hole (31) into which a rotation shaft (30) is inserted; and

a molding member for reducing magnetic flux leakage (40) filling the space (S).

In an embodiment according to the present invention, the molding member for reducing magnetic flux leakage (40) may be filled in the space (S) in a state where the permanent magnet (20) is positioned in each gap between the rotor cores (10).

In an embodiment according to the present invention, preferably, the rotor cores (10) are retained to be coupled with each other by filling a molding member for coupling (60) in a coupling hole (10A) formed in each rotor core (10) by insert molding.

In an embodiment according to the present invention, a protrusion (10′) may be formed outwardly at both ends of the outer circumference and a receiving groove (10″) may be formed inwardly at both ends of the outer circumference, for each rotor core (10), such that the outer surfaces of the permanent magnet (20) contact the protrusion (10′) of the rotor core (10) on its one side and the protrusion (10′) of the rotor core (10) on its other side, and a molding member for scattering prevention (70) is filled in the receiving groove (10″) of the rotor core (10) on the one side and the receiving groove (10″) of the rotor core (10) on the other side by insert molding.

### Advantageous Effects of Invention

According to the present invention, rotor cores having neither base nor bridge are provided and a permanent magnet is arranged in each gap between the plurality of core shaving neither base nor bridge, which allows reduction of the total weight of the rotor cores. Thus, the spoke type rotor of the present invention can significantly reduce the manufacturing costs of the rotor cores.

Also, according to the present invention, a molding member for reducing magnetic flux leakage is filled in a space formed between the inner circumferential surfaces of the plurality of radially arranged rotor cores and of the permanent magnets and a rotation shaft, so as to prevent magnetic flux of the permanent magnets from leaking into the rotation shaft, which allows reduction of core loss. Thus, the spoke type rotor of the present invention can significantly improve motor performance and also achieve a compact motor.

Also, according to the present invention, the plurality of radially arranged cores and the permanent magnets are fastened to each other by filling the molding member for reducing magnetic flux leakage, and at the same time scattering of the permanent magnets that may occur at the high-speed rotation of a motor is prevented by filling a molding member for scattering prevention of the permanent magnets in receiving grooves formed at both ends of the outer circumference of each core. Thus, the spoke type rotor of the present invention can ensure the structural strength and safety of the rotor.

Also, according to the present invention, the plurality of radially arranged cores are coupled with each other by filling a molding member for coupling in a coupling hole formed in each core, without a separate caulking means such as a rivet, which allows not only firm coupling between the cores but also prevention of magnetic flux leakage through the coupling holes. Thus, the spoke type rotor of the present invention can provide a motor with improved performance.

### BRIEF DESCRIPTION OF DRAWINGS

FIG. 1 is a perspective view of a rotor according to the present invention;

FIG. 2 is an exploded perspective view of the rotor according to the present invention;

FIG. 3 is a partial exploded perspective view of the rotor according to the present invention;

FIG. 4 is a cross-sectional view of a spoke type permanent magnet motor according to an embodiment to which the rotor of the present invention applies;

FIG. 5 is a side cross-sectional view of the rotor according to the present invention;

FIG. 6 is a partial enlarged view of the rotor core according to the present invention; and

FIG. 7 is a side cross-sectional view of the rotor according to conventional art.

Hereinafter, the present invention will be described in detail with reference to the accompanying drawings.

### MODE FOR THE INVENTION

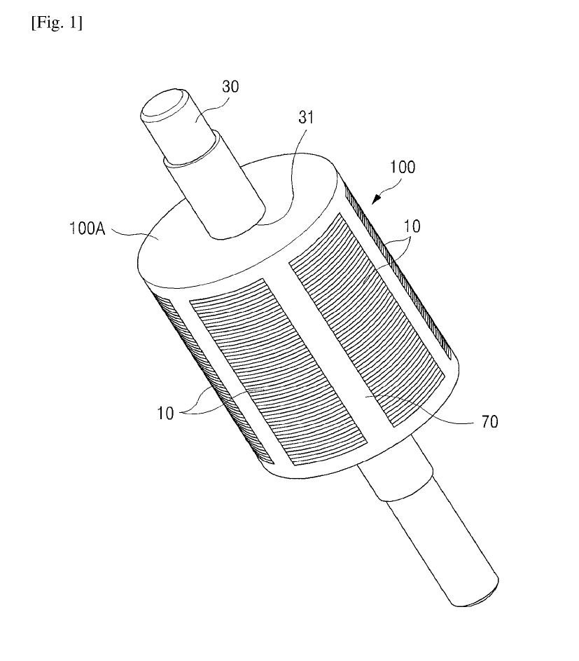

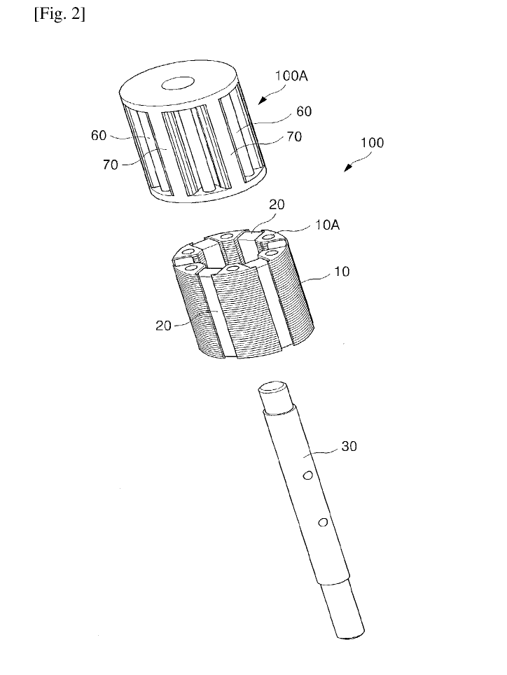

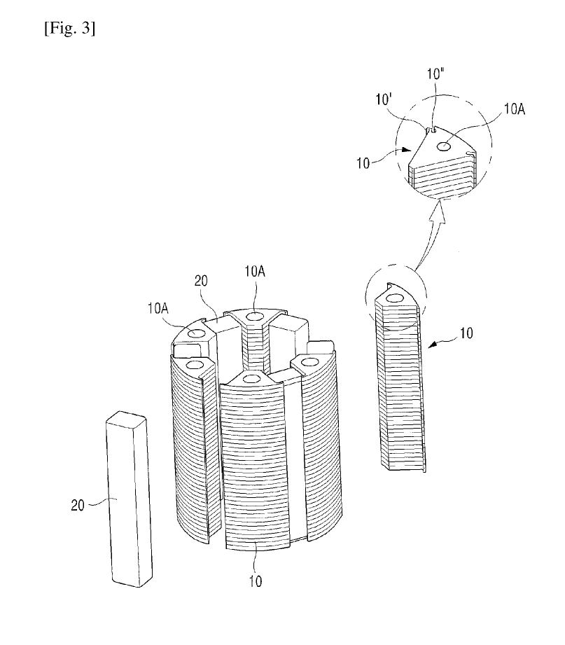

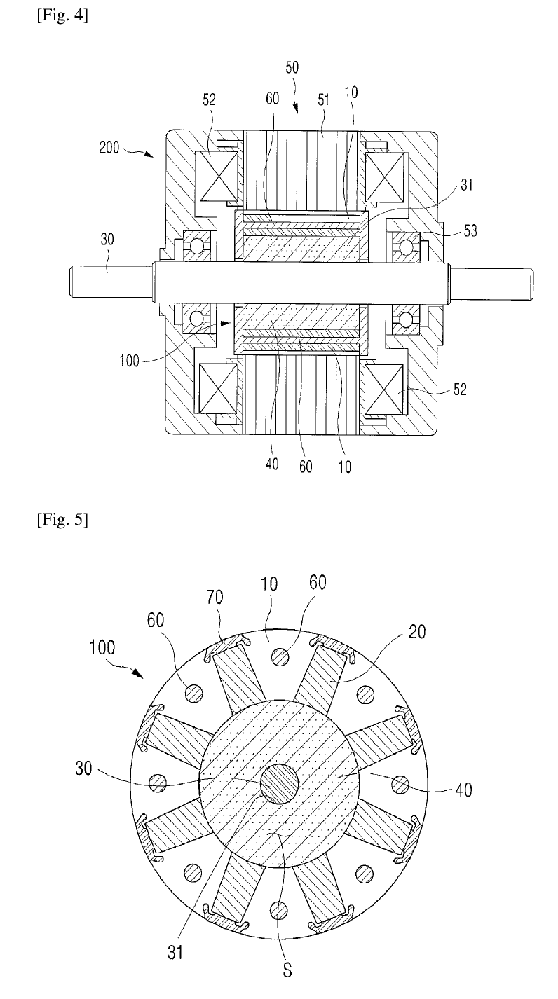

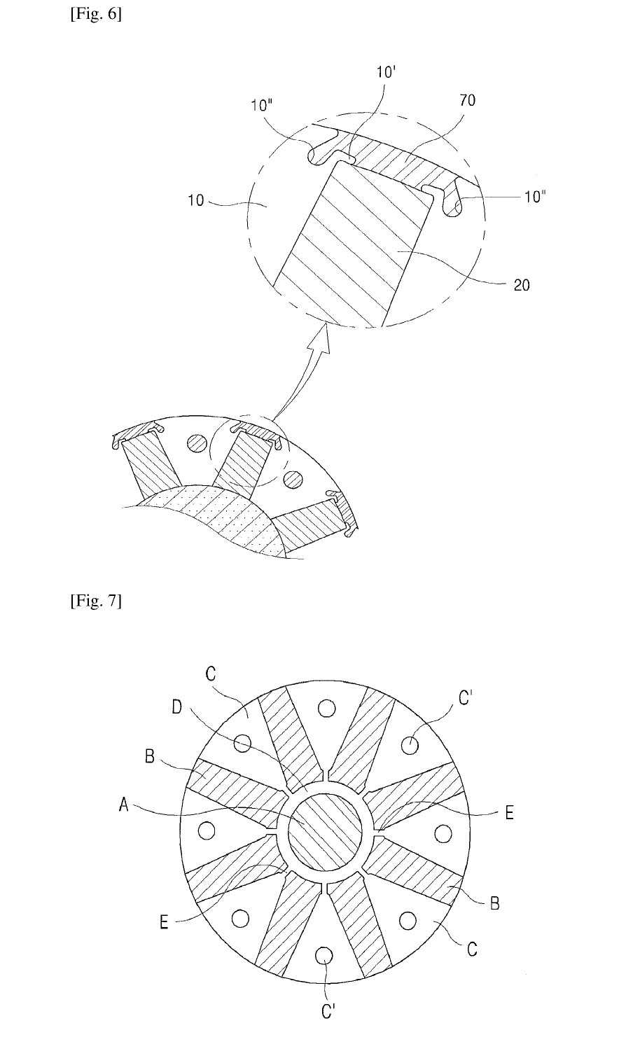

FIG. 1 is a perspective view of a spoke type rotor (100) according to the present invention; FIG. 2 is an exploded perspective view of the rotor (100) according to the present invention; FIG. 3 is a partial exploded perspective view of the rotor according to the present invention; FIG. 4 is a cross-sectional view of a spoke type permanent magnet motor (200) according to an embodiment to which the rotor of the present invention applies; FIG. 5 is a side cross-sectional view of the rotor according to the present invention; and FIG. 6 is a partial enlarged view of the rotor core according to the present invention. The present invention will be described in detail with reference to the accompanying drawings.

The spoke type rotor of the present invention may be constituted by including a plurality of rotor cores (10), radially arranged, having neither base nor bridge; a permanent magnet (20) arranged in each gap between the plurality of rotor cores (10); a space (S) formed between the inner circumferential surfaces of the plurality of rotor cores (10) and of the permanent magnets (20) and a through hole (31) into which a rotation shaft (30) is inserted; and a molding member for reducing magnetic flux leakage (40) filling the space (S).

As illustrated in FIG. 5, a molding member for reducing magnetic flux leakage (40) is filled in the space (S) between the permanent magnet (20) and a rotation shaft (30), such that the magnetic flux of the permanent magnet (20) flows into a stator iron core (51) of a stator (50), illustrated in FIG. 4, through the plurality of rotor cores (10) with no bridge. Thus, the magnetic flux leakage of the permanent magnet (20) into the rotation shaft (30) can be significantly reduced. Thereby, the performance of a motor (200) can be greatly improved owing to reduction of core loss.

Moreover, according to the present invention, the molding member for reducing magnetic flux leakage (40) is filled in the space (S) between the permanent magnet (20) and the rotation shaft (30), in order to prevent magnetic flux leakage of the permanent magnet (20) into the rotation shaft (30). Thus, neither bridge nor base is required for supporting the rotor cores (10), and also the size of the permanent magnet (20) can be made smaller, which leads to significant reduction of the weight of the rotor (100). Thereby, the manufacturing costs can be reduced.

By the filling of the molding member for reducing magnetic flux leakage (40) in the space (S), however, the permanent magnet (20) or rotor core (10) may be scattered at the high-speed rotation of the motor (200), and vibration may occur because of flowability in case where the coupling is not firm.

In order to resolve this issue, as illustrated in FIG. 2 and FIG. 3, according to the present invention, the permanent magnet (20) is positioned in each gap between the plurality of rotor cores (10), and the molding member for reducing magnetic flux leakage (40) is filled in the space (S) inside the mold, such that the molding member (40) retains the coupling of the inner circumferential surface of each of the rotor core (10) and permanent magnet (20) without causing flowability. Also, the rotor cores (10) are retained to be coupled with each other by filling a molding member for coupling (60) in a coupling hole (10A) formed in each rotor core (10) by insert molding. Thus, firm coupling without causing flowability can be achieved.

In addition, as illustrated in FIG. 6, according to the present invention, a protrusion (10′) is formed outwardly at both ends of the outer circumference and a receiving groove (10″) is formed inwardly at both ends of the outer circumference, for each rotor core (10), such that the outer surfaces of the permanent magnet (20) contact the protrusion (10′) of the rotor core (10) on its one side and the protrusion (10′) of the rotor core (10) on its other side, and a molding member for scattering prevention (70) is filled in the receiving groove (10″) of the rotor core (10) on the one side and the receiving groove (10″) of the rotor core (10) on the other side by insert molding. Thereby, the permanent magnet (20) and the rotor core (10) are prevented from scattering outwards at the high-speed rotation of the motor (200).

Meanwhile, a housing (100A) illustrated in FIG. 2 is obtained by insert molding in a state where the rotor cores (10) and the permanent magnets (20) are positioned adjacently and may serve as an insulator. The housing (100A), molding member (40), molding member for coupling (60) and molding member for scattering prevention (70) are formed by insert molding in a state where the rotor cores (10), permanent magnets (20) and rotation shaft (30) are positioned in a mold for insert molding. Thereby, all these constituents can be constituted as a molded member. Thus, the rotation shaft (30) is adhered and coupled to the molding member (40), and no separate shaft assembling process is required.

As illustrated in FIG. 4, the housing (100A) constituting the rotor (100) may be disposed inside the stator (50) and provide the spoke type permanent magnet motor (200). In the drawing, reference numeral 51 indicates a stator iron core, reference numeral 52 indicates a coil, and reference numeral 53 indicates a bearing.

The present invention is described as above with reference to the drawings and embodiments; the present invention is not limited to particular embodiments. A person having ordinary skill in the art will understand that various modifications and changes can be made without departing from the scope of the present invention. Also, the drawings are illustrated simply for helping understand the present invention and should not be construed as limitations on the scope of the claims.

1. A spoke type rotor comprising:
a plurality of rotor cores (10), radially arranged, having neither base nor bridge;
a permanent magnet (20) arranged in each gap between the plurality of rotor cores (10);
a space (S) formed between the inner circumferential surfaces of the plurality of rotor cores (10) and of the permanent magnets (20) and a through hole (31) into which a rotation shaft (30) is inserted; and
a molding member for reducing magnetic flux leakage (40) filling the space (S)

2. The spoke type rotor according to claim 1, wherein the molding member for reducing magnetic flux leakage (40) is filled in the space (S) in a state where the permanent magnet (20) is positioned in each gap between the rotor cores (10).

3. The spoke type rotor according to claim 1, wherein the rotor cores (10) are retained to be coupled with each other by filling a molding member for coupling (60) in a coupling hole (10A) formed in each rotor core (10) by insert molding.

4. The spoke type rotor according to claim 1, wherein a protrusion (10′) is formed outwardly at both ends of the outer circumference and a receiving groove (10″) is formed inwardly at both ends of the outer circumference, for each rotor core (10), such that the outer surfaces of the permanent magnet (20) contact the protrusion (10′) of the rotor core (10) on its one side and the protrusion (10′) of the rotor core (10) on its other side, and a molding member (70) for scattering prevention is filled in the receiving groove (10″) of the rotor core (10) on the one side and the receiving groove (10″) of the rotor core (10) on the other side by insert molding.
